(19) United States
(12) Patent Application Publication
(10) Pub. No.: US 2026/0316980 A1
(43) Pub. Date: Oct. 15, 2026

(54) STRAPPING DEVICE INCLUDING AN ULTRASONIC SEALER

(71) Applicant: Signode Industrial Group LLC, Tampa, FL (US)

(72) Inventors: Dominic Müller, Dietikon (CH); Christian Benz, Zürich (CH); Michael Meng, Gipf-Oberfrick (CH); Philipp Buser, Erlinsbach (CH); Dimitrios Takidis, Dübendorf (CH)

(21) Appl. No.: 19/483,874

(22) PCT Filed: May 14, 2024
(86) PCT No.: PCT/US2024/029216

§ 371 Date: Nov. 12, 2025

Related U.S. Application Data
(60) Provisional application No. 63/504,583, filed on May 26, 2023.

(51) Int. Cl. B65B 13/32

(52) U.S. Cl. CPC B65B 13/32

(57) ABSTRACT

A strapping device comprising an anvil (720) with teeth (734) in a plane angularly offset (θ) from a horizontal axis, i.e. transverse direction of the strap (S) in the strap path, and an ultrasonic sealer (800) comprising a sonotrode (830) with teeth (834) in a plane angularly offset (θ) from the horizontal axis and an ultrasonic transducer to transmit the mechanical vibrations to the sonotrode, wherein the ultrasonic sealer extends longitudinally along an ultrasonic-sealer axis that is angularly offset (β) from a vertical axis (i.e. normal to the transverse direction of the strap (S) in the strap path) and is movable along the ultrasonic-sealer axis between a retracted position (depicted) and a sealing position. Also described is a sonotrode (830) comprising teeth (834) that extend substantially parallel to the strap (S), wherein adjacent sonotrode teeth (834) define grooves each having the same cross-section along its length.

### PRIORITY

This application claims priority to and the benefit of U.S. Provisional Patent Application No. 63/504,583, filed May 26, 2023, the entire contents of which is incorporated herein by reference.

### FIELD

The present disclosure relates to a strapping device for bundling and unitizing loads of goods, and more particularly to a strapping device including an ultrasonic sealer for attaching two overlapping layers of strap to one another to form a strap joint.

### BACKGROUND

A strapping device forms a tensioned loop of plastic strap (such as polyester or polypropylene strap), metal strap (such as steel strap), or paper strap around a load. Strapping machines are one type of strapping device. A typical strapping machine includes a support surface that supports the load, a strap chute that circumscribes the support surface, a strapping head that forms the strap loop, a controller that controls the strapping head to strap the load, and a frame that supports these components. A typical strapping head includes a strap-feeding assembly for feeding strap from a strap supply into and around the strap chute and for retracting the strap so it exits the strap chute and moves radially inwardly into contact with the load, a strap-tensioning assembly for tensioning the strap around the load, and a strap-sealing assembly for cutting the strap from the strap supply and attaching two areas of the strap together to form the strap loop. The strapping machine includes several guides that define strap channels that the strap passes through as it moves between the various assemblies of the strapping head and the strap chute. The strap channels and the strap chute together define a strap path that the strap moves through.

To strap the load, the strapping machine carries out a strapping process including a strap-feeding process, a strap-retraction process, a strap-tensioning process, and a strap-sealing process. The strapping machine first carries out the strap-feeding process during which the strap-feeding assembly feeds strap (with the leading strap end first) from the strap supply through the strap-tensioning assembly, through the strap-sealing assembly, and into and around the strap chute until the leading strap end returns to the strap-sealing assembly. The strapping machine then carries out the strap-retraction process during which the strap-sealing assembly holds the leading strap end while the strap-feeding assembly retracts the strap to pull the strap out of the strap chute and onto and around the load. The strapping machine then carries out the strap-tensioning process during which the strap-tensioning assembly tensions the strap to a designated strap tension. The strapping machine then carries out the strap-sealing process during which the strap-sealing assembly attaches the leading strap end to another portion of the strap to form a strap joint and cuts the strap from the strap supply, thereby forming a tensioned strap loop around the load and completing the strapping process.

### SUMMARY

Various embodiments of the present disclosure provide a strapping device including an ultrasonic sealer.

### BRIEF DESCRIPTION OF THE FIGURES

FIG. 1 is a perspective view of one example embodiment of a strapping device of the present disclosure.

FIGS. 2A and 2B are perspective and front-elevational views, respectively, of the strapping head of the strapping device of FIG. 1.

FIGS. 3A and 3B are perspective views of the strap-sealing assembly of the strapping head of FIGS. 2A and 2B.

FIGS. 4A and 4B are perspective views of the sealing-assembly frame, the anvil assembly, and the ultrasonic-sealing assembly of the strap-sealing assembly of FIGS. 3A and 3B.

FIGS. 5A and 5B are perspective and side-elevational views, respectively, of the anvil of the anvil assembly of the strap-sealing assembly of FIGS. 3A and 3B.

FIGS. 6A and 6B are perspective and front-elevational views, respectively, of the ultrasonic-sealing assembly of the strap-sealing assembly of FIGS. 3A and 3B.

FIG. 6C is a perspective view of the ultrasonic sealer of the ultrasonic-sealing assembly of FIGS. 6A and 6B.

FIG. 6D is a side-elevational view of the sonotrode head of the sonotrode of the ultrasonic sealer of FIG. 6C.

FIG. 7A is a side-elevational view of the sealing-assembly frame, the anvil assembly, and the ultrasonic-sealing assembly of the strap-sealing assembly of FIGS. 3A and 3B with the anvil assembly in its sealing position and the ultrasonic-sealing assembly in its retracted position.

FIG. 7B is similar to FIG. 7A but shows the anvil assembly in its retracted position.

FIG. 8A is a cross-sectional side-elevational view of the sealing-assembly frame, the anvil assembly, and the ultrasonic-sealing assembly of the strap-sealing assembly of FIGS. 3A and 3B taken along line 8A-8A of FIG. 4A with the anvil assembly in its sealing position and the ultrasonic-sealing assembly in its retracted position.

FIG. 8B is similar to FIG. 8A but shows the ultrasonic-sealing assembly in its sealing position.

FIGS. 9A-9C are side-elevational views of the sonotrode head of FIG. 6D, the anvil of FIGS. 5A and 5B, and upper and lower strap portions during a strap-sealing cycle.

FIG. 10 is a top-plan view of an example strap joint formed by the strapping head of FIGS. 2A and 2B.

FIGS. 11A-11E are cross-sectional front-elevational views of part of the strap-sealing assembly of FIGS. 2A and 2B during the strapping process.

### DETAILED DESCRIPTION

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

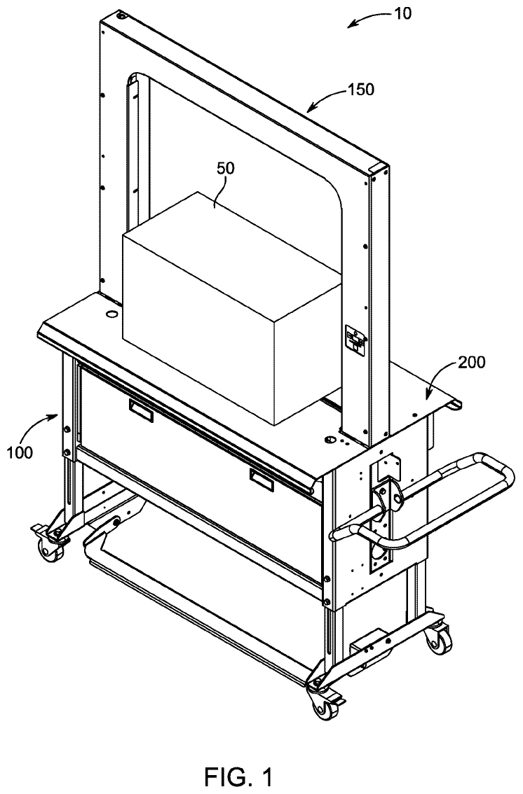

Various embodiments of the present disclosure provide a strapping device configured to carry out a strapping process. FIGS. 1-11E show one example embodiment of a strapping device of the present disclosure in the form of a strapping machine 10 and components thereof. The strapping machine 10 is configured to form a tensioned loop of strap drawn from a strap supply (not shown) around a load 50 and includes a frame 100, a strap chute 150, a load supporter 200, a strapping head 300, and a controller.

The frame 100 supports some (or all depending on the embodiment) of the other components of the strapping machine 10 and may be formed of any suitable components arranged in any suitable configuration. The load supporter 200 is supported by the frame 100 and is sized, shaped, positioned, oriented, and otherwise configured to support loads—such as the load 50 shown in FIG. 1—as they are strapped by and as they move through the strapping machine 10. The load supporter 200 includes a support surface (not labeled) on which loads are positioned during strapping and over which loads move as they move through the strapping machine 10. In this example embodiment, the support surface includes multiple rollers that facilitate movement of the loads across the load supporter 200. The rollers may be driven or undriven. In other embodiments, the support surface includes any other suitable driven conveyor.

The strap chute 150 is supported by the frame 100 and circumscribes the support surface of the load supporter 200. The strap chute 150 defines a strap path that the strap follows when fed through the strap chute 150 and from which the strap is removed when retracted. The strap chute 150 includes two spaced-apart first and second upstanding legs (not labeled); an upper connecting portion (not labeled) that spans the first and second legs; a first lower connecting portion (not labeled) within or beneath the load supporter 200 that connects the strapping head 300 with the first upstanding leg; and a second lower connecting portion (not labeled) within or beneath the load supporter 200 that connects the strapping head 300 with the second upstanding leg. The radially inward wall of the strap chute 150 is formed from one or more gates that are biased to a closed position that enables the strap to traverse the strap path when fed through the strap chute 150. During the strapping process (described below), these gates move to an open position before the retract cycle to enable the strap to be retracted from the strap chute 150 and move radially inward into contact with the load. A leading-end sensor communicatively connected to the controller is positioned and otherwise configured to detect the leading end of the strap when the leading end has traversed the strap chute 150 and returned to the strapping head 300 during the strap-feeding process, as explained below.

The strapping head 300 is configured to carry out the strapping process and includes a head frame 305 mounted to the frame 100 and supporting a strap-feeding assembly 400, a strap-tensioning assembly 500, a strap-sealing assembly 600, and one or more guides configured to guide the strap between these assemblies and the strap chute 150. In this example embodiment, the strapping head 300 is removably attached to the frame 100, though in other embodiments the strap-feeding assembly 400, the strap-tensioning assembly 500, and/or the strap-sealing assembly 600 are removably attached to the frame 100.

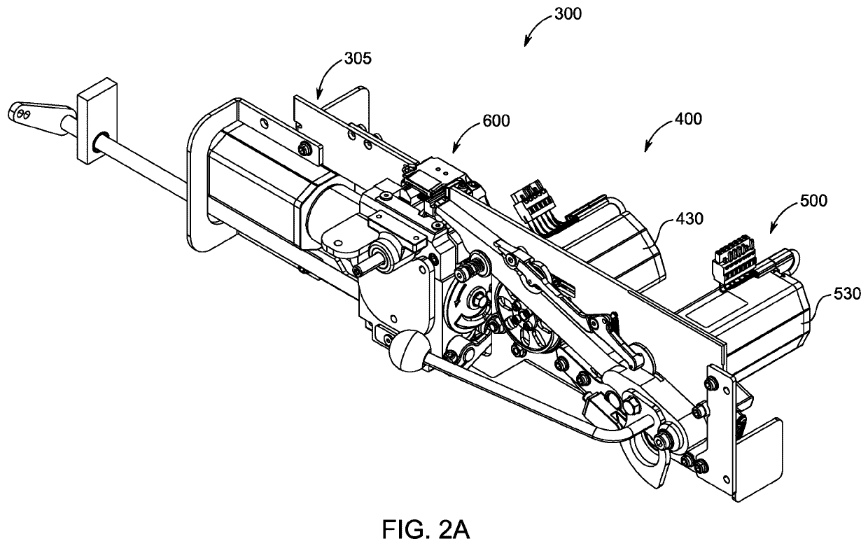

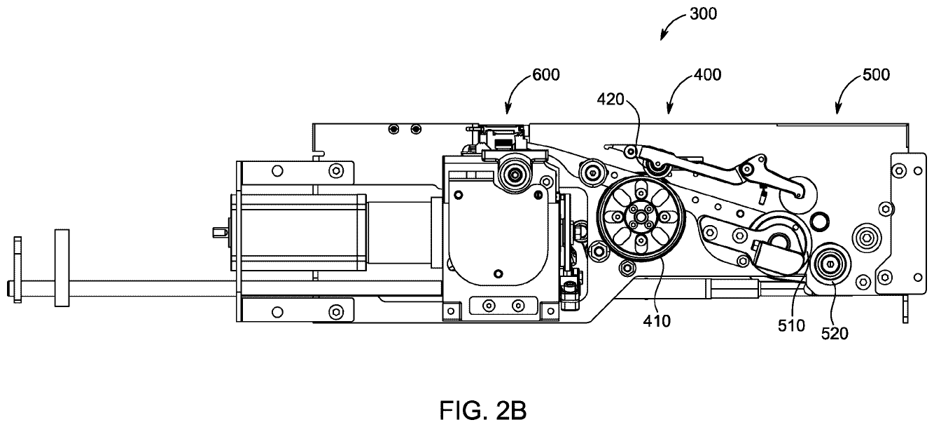

The strap-feeding assembly 400, best shown in FIGS. 2A and 2B, is configured to feed strap from the strap supply into and around the strap chute 150 and to, after the leading-end sensor senses the leading end of the strap and the strap-sealing assembly 600 holds the leading end, retracts the strap so it exits the strap chute 150 and contacts the load 50. The strap-feeding assembly 400 includes a drive roller 410, a pinch roller 420, and a strap-feeding actuator 430. The drive roller 410 is cylindrical (here, disc-shaped) and is mounted to the head frame 305 so the drive roller 410 is rotatable relative to the head frame 305 about a drive-roller rotational axis. The pinch roller 420 is cylindrical (here, disc-shaped) and is mounted to the head frame 305 such that the pinch roller 420 is freely rotatable relative to the head frame 305 about a pinch-roller rotational axis. The drive roller 410 and the pinch roller 420 are sized, shaped, positioned, and oriented such that their respective rotational axes are generally parallel and coplanar. The pinch roller 420 is positioned adjacent the drive roller 410 such that a nip is formed between the two rollers. The nip is sized such that the strap S can be received in the nip and such that the drive roller 410 and the pinch roller 420 apply sufficient force to the strap S to enable the drive roller 410 to feed and retract the strap S. In certain embodiments, at least part of the external cylindrical surface of the drive roller 410 and/or the pinch roller 420 is knurled or coated with a friction-enhancing material to facilitate engaging the strap.

The strap-feeding actuator 430, which is an electric motor in this example embodiment but may include any suitable actuator, is mounted to the head frame 305 and is operably connected to the drive roller 410 and configured to drive the drive roller 410 in opposing feed and retract rotational directions. The strap-feeding actuator 430 may be operably connected to the drive roller 410 in any suitable manner, such as via a keyed or splined connection and/or via a suitable drive train.

The strap-tensioning assembly 500, best shown in FIGS. 2A and 2B, is configured to tension the strap around the load 50. The strap-tensioning assembly 500 includes a drive roller 510, a pinch roller 520, and a strap-tensioning actuator 530. The drive roller 510 is cylindrical (here, disc-shaped) and is mounted to the head frame 305 so the drive roller 510 is rotatable relative to the head frame 305 about a drive-roller rotational axis. The pinch roller 520 is cylindrical (here, disc-shaped) and is mounted to the head frame 505 such that the pinch roller 520 is freely rotatable relative to the head frame 305 about a pinch-roller rotational axis. The drive roller 510 and the pinch roller 520 are sized, shaped, positioned, and oriented such that their respective rotational axes are generally parallel and coplanar. The pinch roller 520 is positioned adjacent the drive roller 510 such that a nip is formed between the two rollers. The nip is sized such that the strap S can be received in the nip and such that the drive roller 510 and the pinch roller 520 apply sufficient force to the strap S to enable the drive roller 510 to tension the strap S around the load. In certain embodiments, at least part of the external cylindrical surface of the drive roller 510 and/or the pinch roller 520 is knurled or coated with a friction-enhancing material to facilitate engaging the strap.

The strap-tensioning actuator 530, which is an electric motor in this example embodiment but may include any suitable actuator, is mounted to the head frame 305 and is operably connected to the drive roller 510 and configured to drive the drive roller 510 in a tensioning rotational direction (which is the same rotational direction as the retract rotational direction in this example embodiment). The strap-tensioning actuator 530 may be operably connected to the drive roller 510 in any suitable manner, such as via a keyed or splined connection and/or via a suitable drive train.

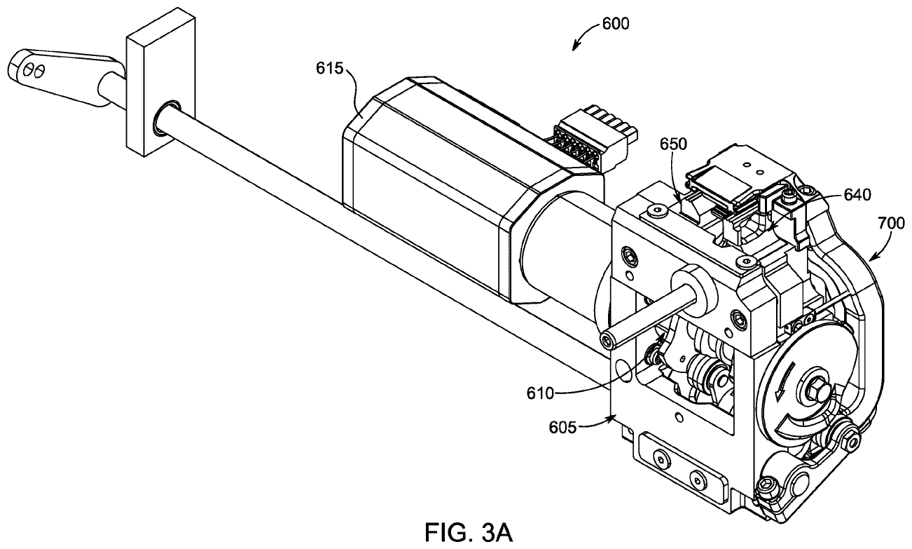

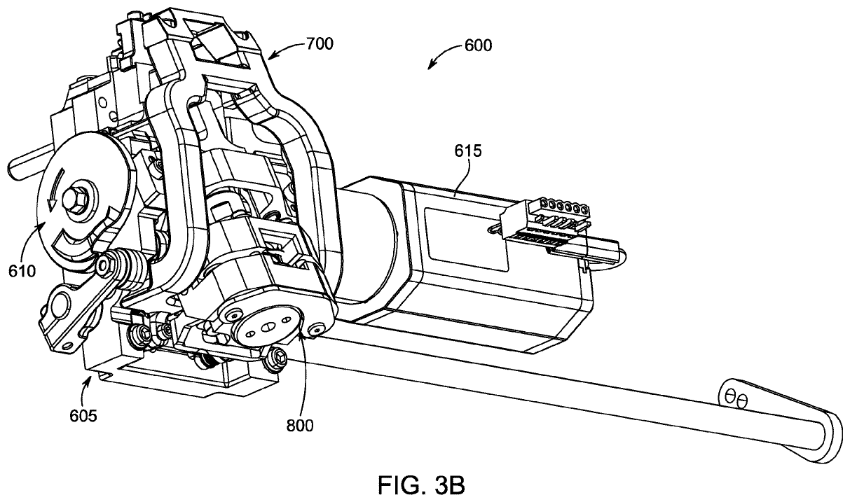

The strap-sealing assembly 600, best shown in FIGS. 3A and 3B, is supported by the head frame 305 and configured to, after the strap-tensioning assembly 500 tensions the strap to the designated tension, attach two overlapping portions of the strap to one another to form a strap joint and cut the strap from the strap supply. The strap-sealing assembly 600 includes a sealing-assembly frame 605, a drive assembly 610 including a strap-sealing actuator 615, a leading-end guide 630, a first strap clamp 640, a second strap clamp 650, a strap cutter 660, an anvil assembly 700, and an ultrasonic-sealing assembly 800.

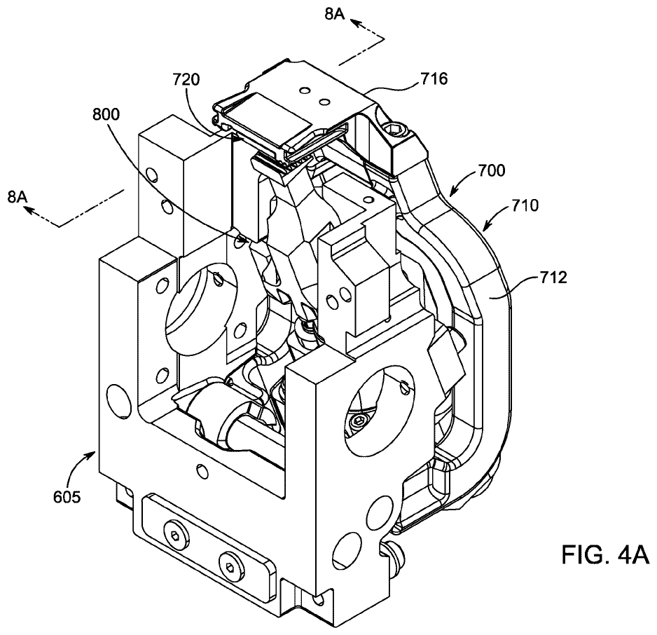

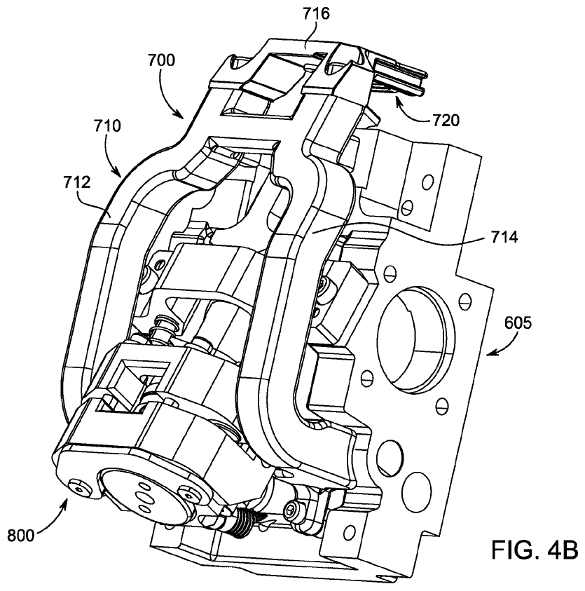

The sealing-assembly frame 605, which is best shown in FIGS. 3A-4B, supports some (or all) of the other components of the sealing assembly 600 and may be formed of any suitable components arranged in any suitable configuration. In this example embodiment, the sealing-assembly frame 605 is mounted to the head frame 305 in any suitable manner (such as via fasteners) such that it is positioned beneath the work platform W.

The drive assembly 610 is operably connected to various components of the strap-sealing assembly 600—including the leading-end guide 630, the first strap clamp 640, the second strap clamp 650, the strap cutter 660, the anvil assembly 700, and the ultrasonic-sealing assembly 800—to move those components as described below to carry out the strapping process. In this example embodiment, the drive assembly 610 includes a camshaft including multiple cams. The cams are shaped, positioned, oriented, and otherwise configured to drive the various components of the strap-sealing assembly 600 during the strapping process, as described below. The camshaft is rotatably supported by the sealing-assembly frame 605 via suitable bearings such that the camshaft can rotate relative to the sealing-assembly frame 605. The strap-sealing actuator 615, which is a motor in this example embodiment but may be any other suitable actuator in other embodiments, is operably connected to the camshaft (such as via a suitable coupling or a splined or keyed connection) and configured to rotate the camshaft one full rotation (though it may be more than or less than one full rotation in other embodiments) to carry out the strapping process. The camshaft—and more particularly the cams that are fixed in rotation with the camshaft—controls the movement of the various components of the strap-sealing assembly 600 during the strapping process. Although not labeled or described in detail, the drive assembly 610 includes suitable actuators that operably connect certain of the cams to the leading-end guide 630, the first strap clamp 640, the second strap clamp 650, the strap cutter 660, the anvil assembly 700, and the ultrasonic-sealing assembly 800 to move these components as described below as the camshaft rotates during the strapping process.

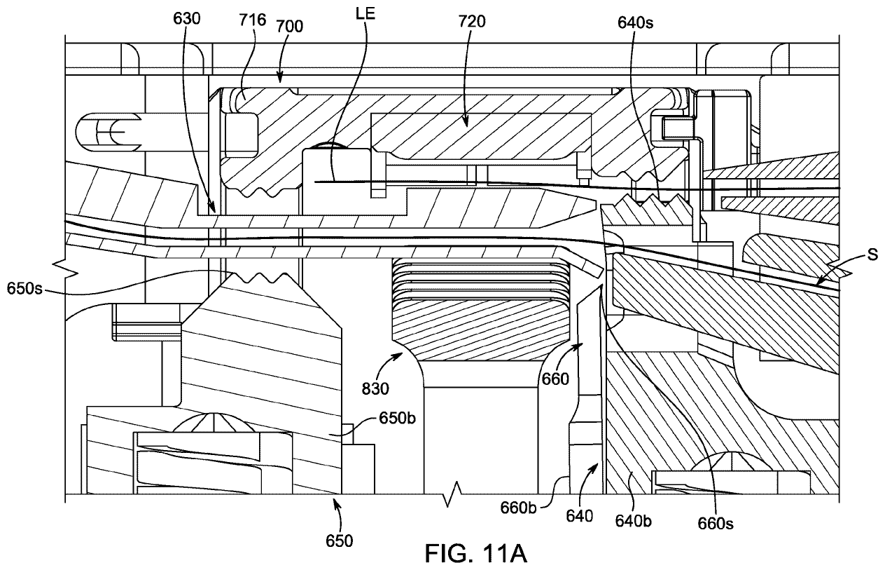

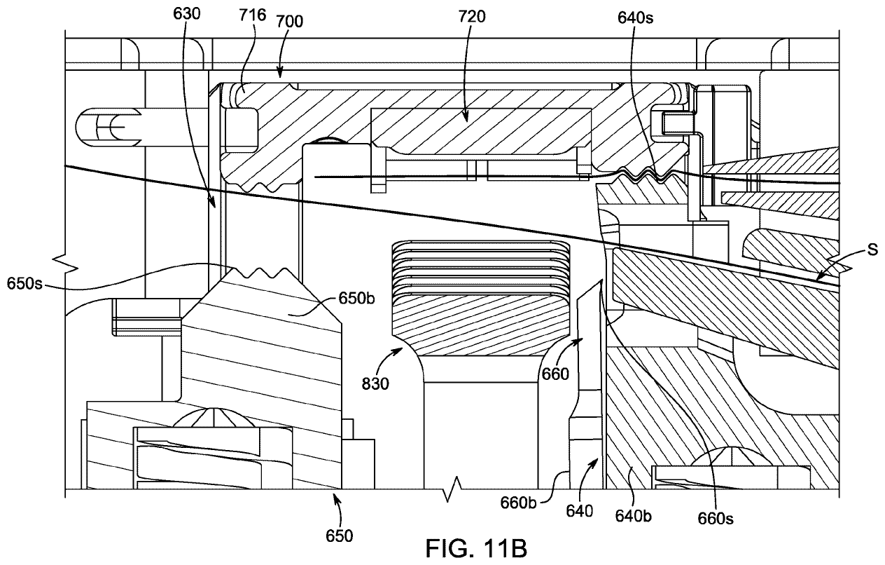

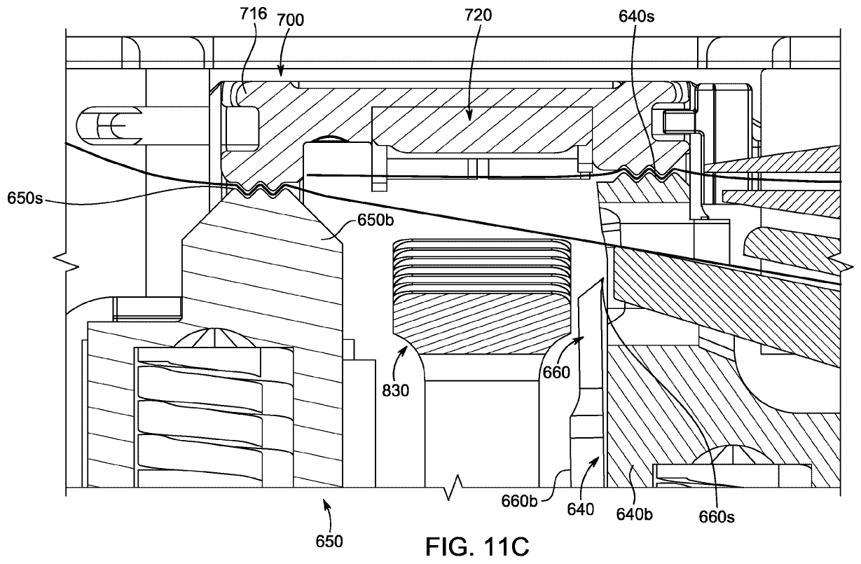

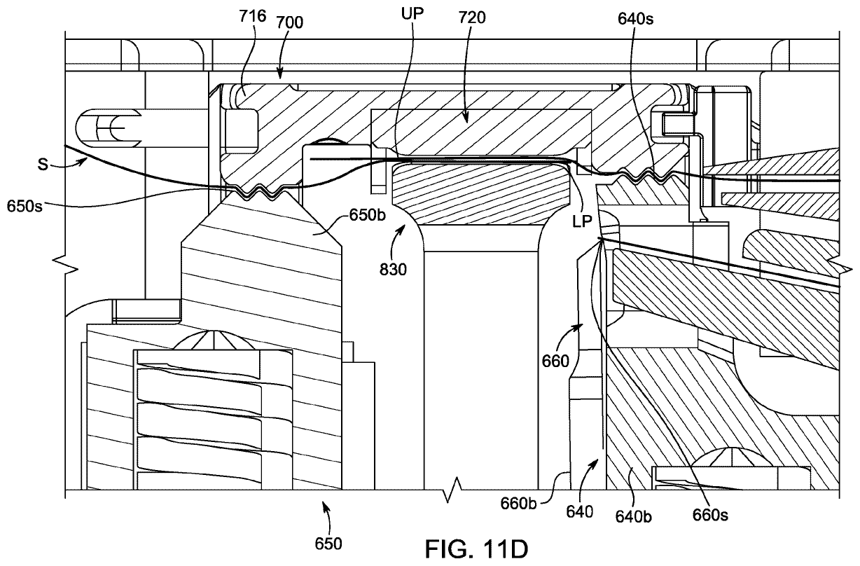

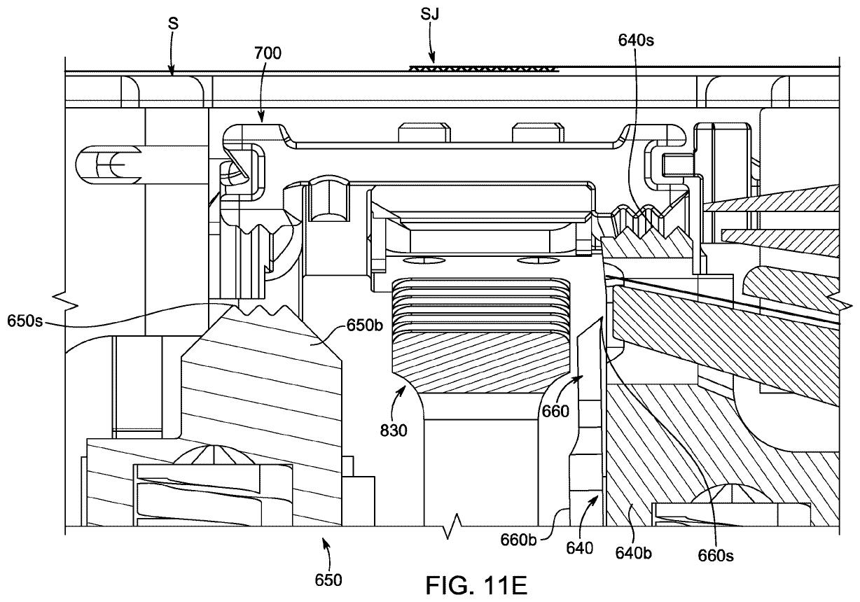

The leading-end guide 630, which is shown in FIG. 11A, is configured to guide the leading end of the strap into the strap chute 150 at the start of the strap-feeding cycle. The leading-end guide 630 is movable via the drive assembly 610 between a guiding position (FIG. 11A) in which the leading-end guide 630 is in the strap path and a retracted position in which the leading-end guide 630 is removed from the strap path (FIGS. 11B-11E). The first strap clamp 640, which is best shown in FIGS. 11A-11E, is configured to clamp a portion of the strap against the anvil assembly 700 at certain points during the strapping process. The first strap clamp 640 includes a first-strap-clamp body 640b defining a strap passage therethrough and including a clamping surface 640s. The first strap clamp 640 is movable via the drive assembly 610 and relative to the anvil assembly 700 between a retracted position (FIGS. 11A and 11E) and a clamping position (FIGS. 11B-11D). The second strap clamp 650, which is best shown in FIGS. 11A-11E, is also configured to clamp a portion of the strap against the anvil assembly 700 at certain points during the strapping process. The second strap clamp 650 includes a second-strap-clamp body 650b including a clamping surface 650s. The second strap clamp 650 is movable via the drive assembly 610 and relative to the anvil assembly 700 between a retracted position (FIGS. 11A, 11B, and 11E) and a clamping position (FIGS. 11C and 11D). The strap cutter 660, which is best shown in FIGS. 11A-11E, is configured to cut the strap at a certain point during the strapping process. The strap cutter 660 includes a strap-cutter body 660b including a cutting surface 660s. The strap cutter 660 is movable via the drive assembly 610 between a retracted position (FIGS. 11A-11C and 11E) and a cutting position (FIG. 11D).

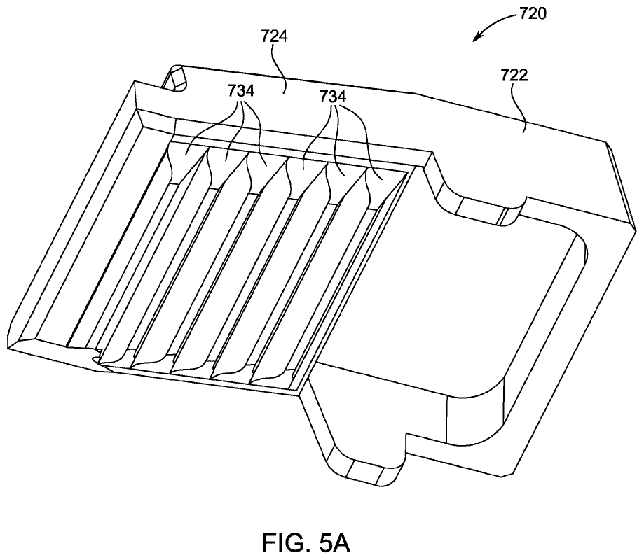

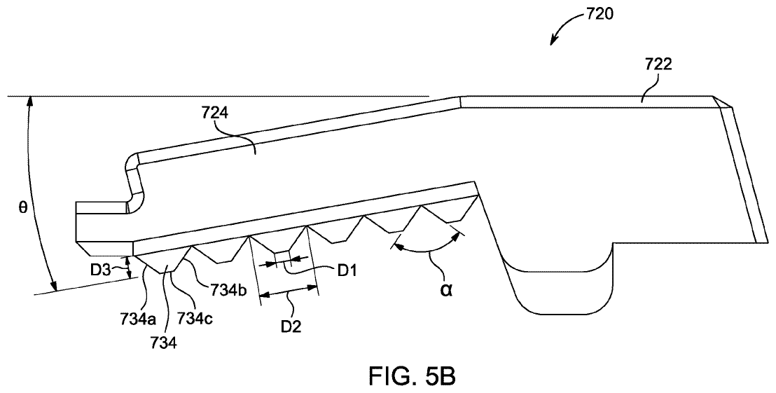

The anvil assembly 700, which is best shown in FIGS. 4A-5B, acts as a clamping surface against which the first and second strap clamps 640 and 650 and the ultrasonic sealer 810 clamp the strap during the strapping process. The anvil assembly 700 includes an anvil support 710 and an anvil 720. The anvil support 710 includes first and second curved arms 712 and 714 and a head 716. One end of each arm 712 and 714 of the anvil support 710 is attached to the head 716 and the other end of each arm 712 and 714 is pivotably attached to the sealing-assembly frame 605. The anvil 720 includes an anvil body 722 and a tooth support 724 extending at an angle from the anvil body 722. Multiple elongated anvil teeth 734 having a triangular cross-section are formed on the underside of the tooth support 724. This example anvil 720 includes six teeth, though it may include any other suitable quantity of teeth in other embodiments. Each anvil tooth 734 includes opposing planar, angled side surfaces 734a and 734b and a substantially planar contact surface 734c connecting the side surfaces 734a and 734b. The anvil teeth 734 together define an anvil contact plane that forms an angle θ relative to a horizontal plane when the anvil assembly 700 is in its sealing position (explained below). The horizontal plane in this instance corresponds to the transverse direction of the strap path (and strap in the strap path). In this example embodiment, the anvil contact plane is defined by the substantially coplanar contact surfaces 734c of the anvil teeth 734. The angle θ is between 0 and 60 degrees and most preferably between 0 and 10 degrees in this example embodiment. The side surfaces of adjacent anvil teeth are separated by an angle α (which is which is 90 degrees in this example embodiment but may be any suitable angle in other embodiments) such that substantially V-shaped grooves are formed between adjacent anvil teeth. The cross-section of these grooves (and thus the cross-section of the teeth that form the grooves) is substantially constant along their entire length. The base of each anvil tooth 734 has a width D1, and the contact surface 734c of each anvil tooth 734 has a width D2 that is less than D1. Each anvil tooth 734 has a height D3. In this example embodiment, D1 is 0.5 millimeters, D2 is 2 millimeters, and D3 is 0.75 millimeters (though these dimensions may differ in other embodiments). The anvil teeth extend substantially parallel to the strap path and the longitudinal direction of the strap and have a length that is greater than or equal to the length of the sonotrode teeth (described below) in this example embodiment.

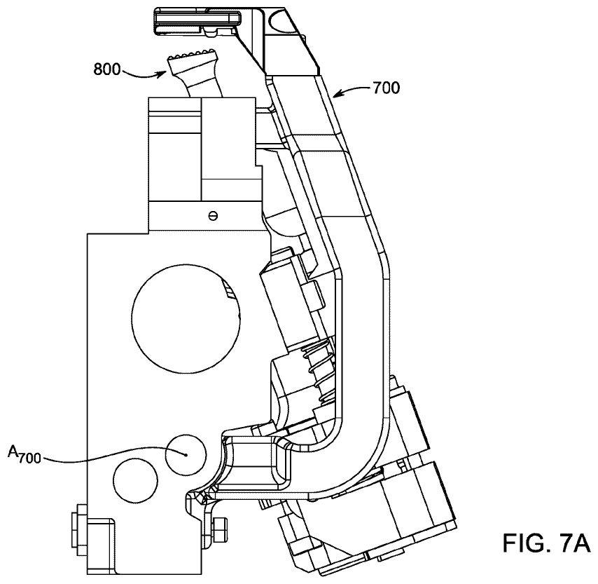

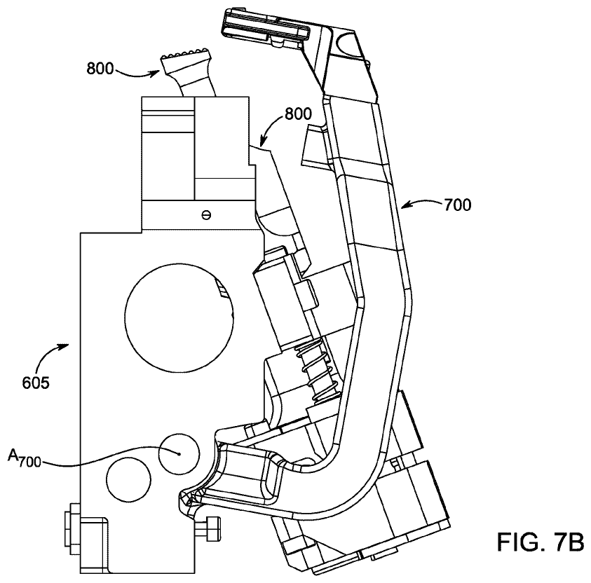

The anvil 720 is attached to the head 716 of the anvil support 710 such that the teeth 734 of the anvil 720 face the ultrasonic sealer 810 (described below). In this example embodiment, the anvil 720 is removably attached to the head 716 via fasteners to enable an operator to replace the anvil 720 when the teeth 734 have become too worn to operate properly. The anvil support 710—and thus the entire anvil assembly 700 including the anvil 720 attached to the anvil support 710—is pivotable relative to various components of the sealing assembly 600 (including the ultrasonic-sealing assembly 800) about an anvil-assembly pivot axis A700 (FIGS. 7A and 7B) between a sealing position (FIGS. 4A, 7A, 8A, and 11A-11D) in which the anvil 720 is above the strap path and a retracted position (FIGS. 7B, 8B, and 11E) in which the anvil 720 is removed from the strap path such that the anvil assembly 700 does not interfere with removal of the load from the strapping machine 10. The drive assembly 610 is configured to move the anvil assembly 700 between the sealing and retracted positions, as explained above.

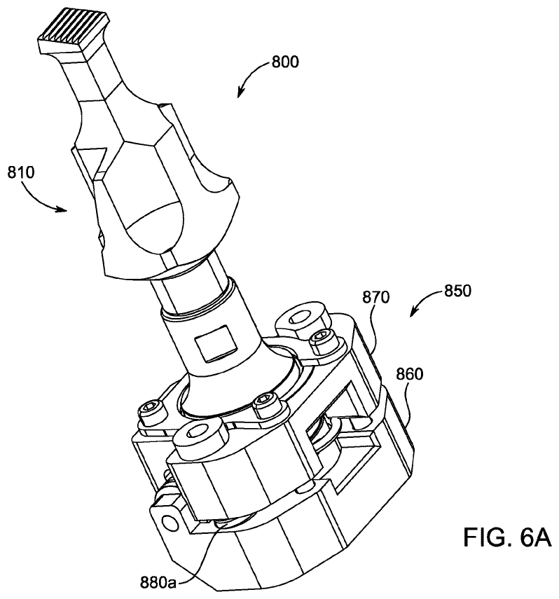

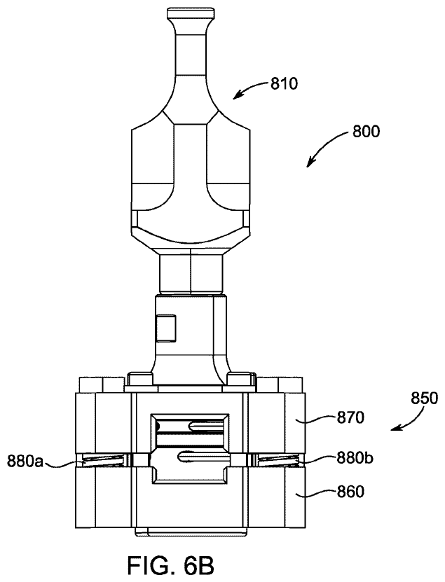

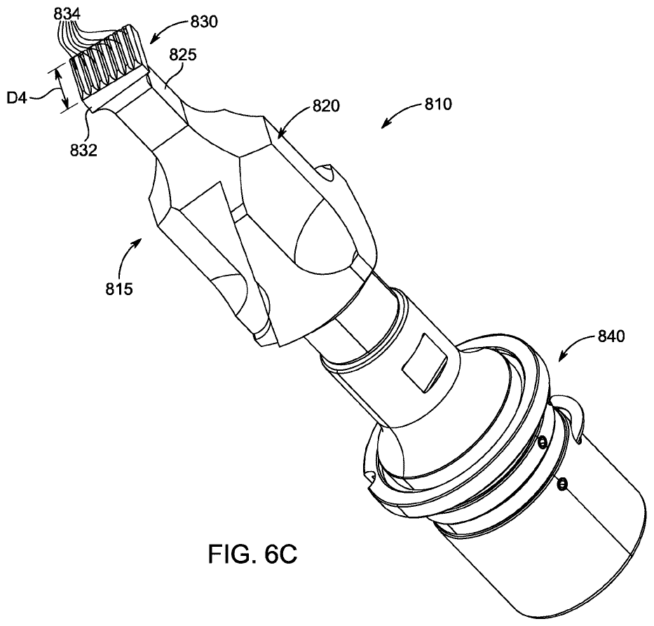

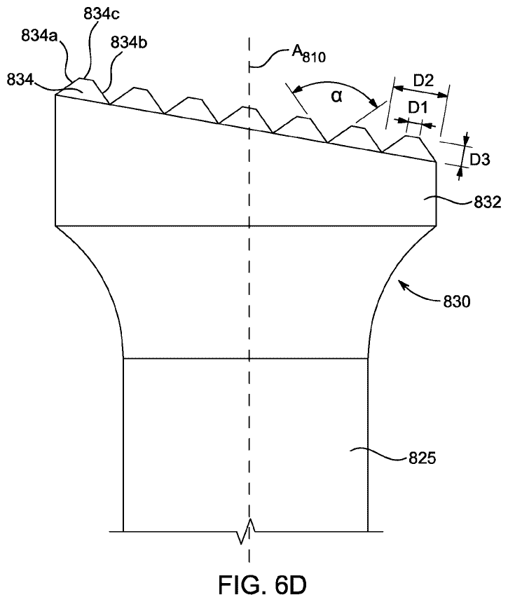

The ultrasonic-sealing assembly 800, which is best shown in FIGS. 6A-6D, is configured to impart ultrasonic vibrations to two overlapping portions of strap to attach them to one another to form a strap joint. The ultrasonic-sealing assembly 800 includes an ultrasonic sealer 810 and an ultrasonic-sealer support 850.

The ultrasonic sealer 810 includes a sonotrode 815 and an ultrasonic transducer 840 and extends longitudinally along an ultrasonic-sealer axis A₈₁₀. The sonotrode 815 includes a sonotrode body 820, a sonotrode neck 825 connected to (and here integrally formed with) the sonotrode body 820, and a sonotrode head 830 connected to (and here integrally formed with) the sonotrode neck 825. As best shown in FIG. 6D, the sonotrode head 830 includes a tooth support 832. Multiple elongated sonotrode teeth 834 having a triangular cross-section are formed on the top surface of the tooth support 824. This example sonotrode includes seven teeth, though it may include any other suitable quantity of teeth in other embodiments. Each sonotrode tooth 834 includes opposing planar, angled side surfaces 834a and 834b and a substantially planar contact surface 834c connecting the side surfaces 834a and 834b. The sonotrode teeth 834 together define a sonotrode contact plane that is transverse to the ultrasonic-sealer axis A₈₁₀ (though their orientation may differ in other embodiments). In this example embodiment, the sonotrode contact plane is defined by the substantially coplanar contact surfaces 834c of the sonotrode teeth 834. The side surfaces of adjacent sonotrode teeth are separated by the angle α such that substantially V-shaped grooves are formed between adjacent sonotrode teeth. The cross-section of these grooves (and thus the cross-section of the teeth that form the grooves) is substantially constant along their entire length. The base of each sonotrode tooth 834 has the width D1, and the contact surface 834c of each sonotrode tooth 834 has the width D2. Each sonotrode tooth 734 has the height D3. The sonotrode teeth extend substantially parallel to the strap path and the longitudinal direction of the strap (as well as the anvil teeth) and have a length that is less than or equal to the length of the anvil teeth in this example embodiment. In other words, the sonotrode teeth 834 are sized, shaped, oriented, and otherwise configured substantially identically to the anvil teeth 734 (though they may differ in other embodiments).

The ultrasonic transducer 840 is powered by a suitable power source and configured to convert high-frequency electrical signals received from that power source into high-frequency mechanical vibrations in the ultrasound range, such as 20-100 kilohertz. Preferably, the ultrasonic transducer 840 is configured to generate vibrations in the range of 20 to 40 kilohertz. More preferably, the ultrasonic transducer 840 is configured to generate vibrations in the range of 34 to 36 kilohertz. Most preferably, the ultrasonic transducer is configured to generate vibrations in the range of 35 kilohertz. The ultrasonic transducer 840 is connected to the sonotrode body 820 of the sonotrode 810 such that the mechanical vibrations generated by the ultrasonic transducer 840 are transmitted to the sonotrode 810, and the sonotrode 810 is sized, shaped, oriented, and otherwise configured such that these vibrations are transmitted to the sonotrode head 830, including the sonotrode teeth 834. Accordingly, the ultrasonic transducer 840 is configured to convert high-frequency electrical signals into mechanical vibration of the sonotrode teeth 834 at ultrasonic frequencies.

The ultrasonic-sealer support 850 is configured to support the ultrasonic sealer 810 and includes a lower support 860, an upper support 870, and first and second support-biasing elements 880a and 880b. The ultrasonic transducer 840 is mounted to the lower support 860, such as via suitable fasteners or retainers. The upper support 870 is movably attached to the lower support 860, such as via suitable fasteners, such that the upper support 870 can translate toward and away from the lower support 860 relative to the ultrasonic sealer 810. The support-biasing elements 880a and 880b, which are compression springs in this example embodiment but may be any other suitable biasing elements in other embodiments, are configured to bias the upper support 870 away from the lower support 860. The ability of the upper and lower supports 860 and 870 to move relative to one another compensates for varying strap thicknesses. In other words, the lower support and the upper support have a first configuration in which they are separated by a first distance and a second configuration in which they are separated by a second, smaller distance, and the biasing elements bias the supports to the first configuration.

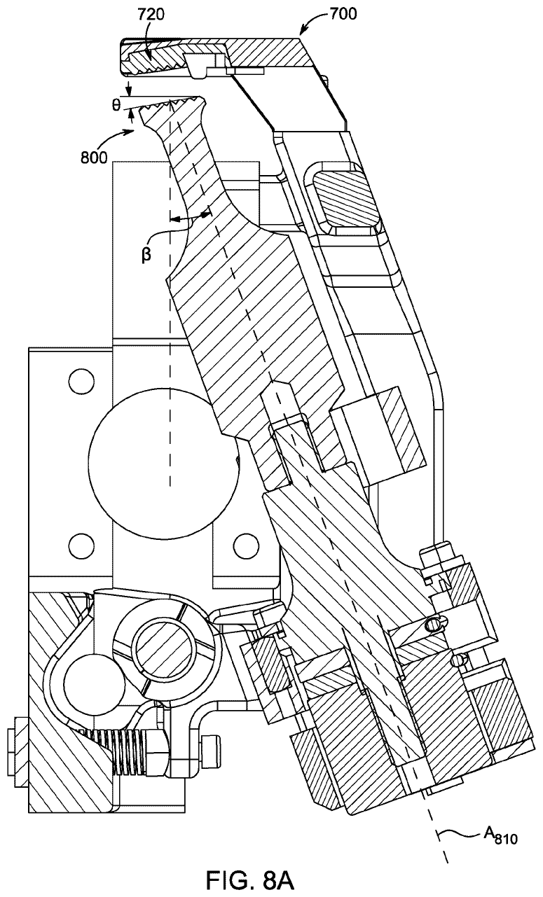

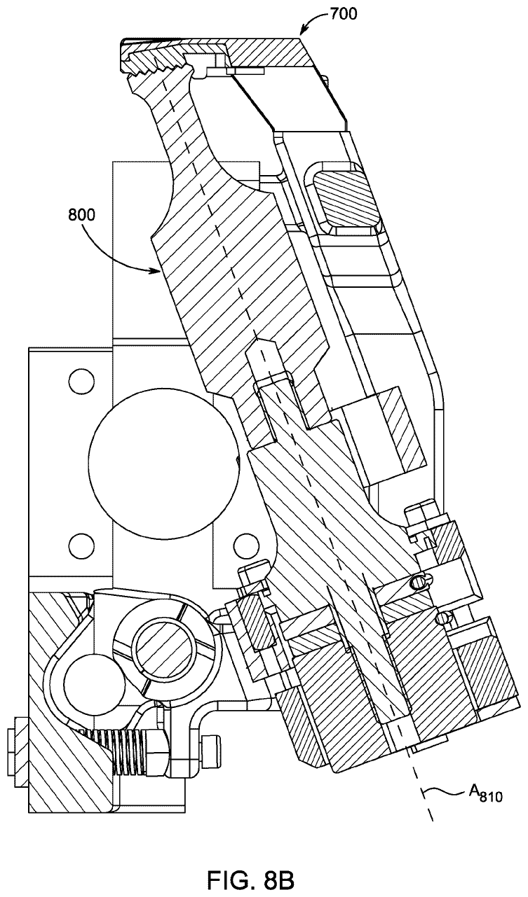

The ultrasonic-sealing assembly 800 is mounted to the sealing-assembly frame 605, such as via a suitable bracket and fasteners, such that the sonotrode contact plane forms the angle θ relative to a horizontal plane and such that the ultrasonic-sealer axis A₈₁₀ forms an angle β relative to a vertical axis, as best shown in FIGS. 8A and 8B. The horizontal plane in this instance corresponds to the transverse direction of the strap path (and strap in the strap path). The contact surfaces 834c of the sonotrode teeth 834 are therefore substantially parallel to the contact surfaces 734c of the anvil teeth 734 (and the anvil and sonotrode contact planes are substantially parallel). The ultrasonic-sealing assembly 800 (and in particular the ultrasonic sealer 810) is longitudinally movable relative to the sealing-assembly frame 605 and the anvil assembly 700 along the ultrasonic-sealer axis A₈₁₀ via the drive assembly 610 between a retracted position (FIG. 8A) and sealing position (FIG. 8B). The angle θ formed by the sonotrode teeth 834 does not change as the ultrasonic-sealing assembly 800 moves between its retracted and sealing positions. The angle β is between 0 and 60 degrees and most preferably between 0 and 10 degrees in this example embodiment. In certain embodiments, the angle θ and the angle β are the same such that the sonotrode contact plane formed by the sonotrode teeth 834 is substantially perpendicular to the ultrasonic-sealer axis A₈₁₀.

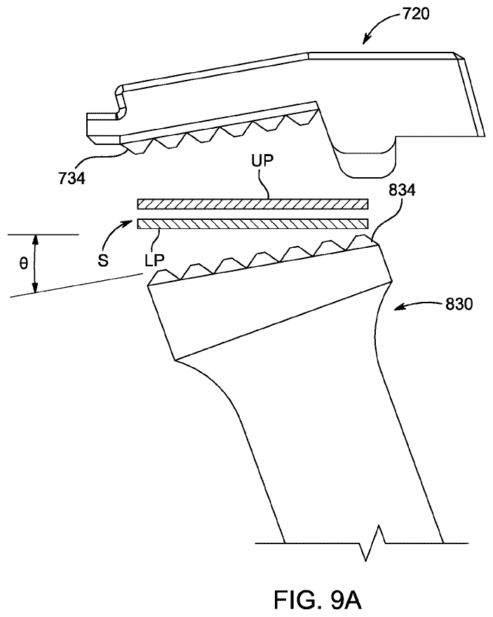

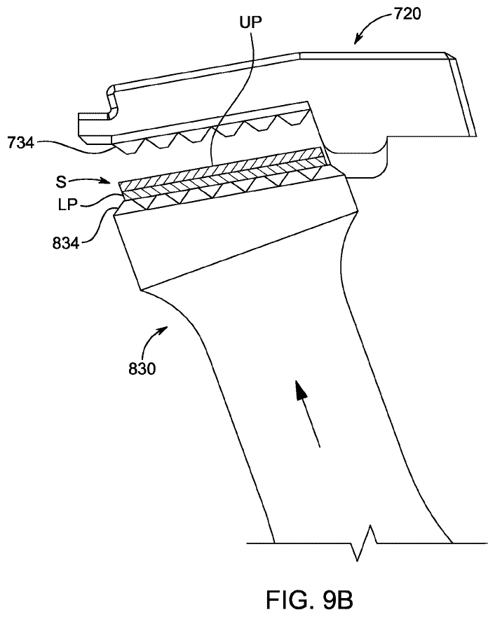

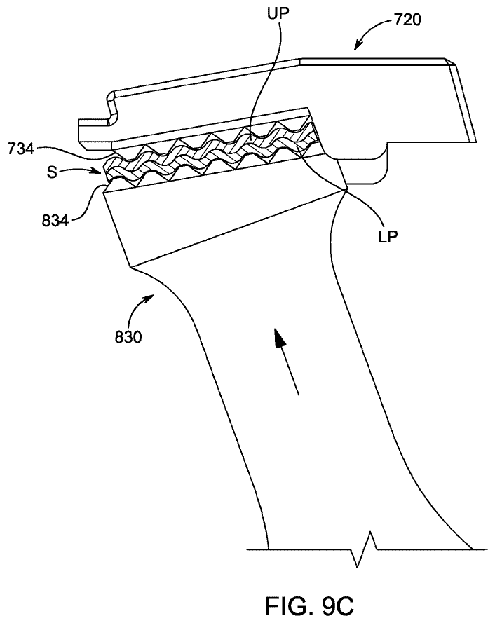

When the ultrasonic sealer 810 is in the retracted position, it is spaced-apart from the anvil 720 and removed from the strap path, as shown in FIG. 9A. In FIGS. 9A-9C, the strap path extends into and out of the page. The space between the anvil and sonotrode teeth and the strap is enlarged in FIG. 9A for clarity. The sonotrode head 830 of the sonotrode 810 is removed from the strap path to enable the other components of the strapping head 300 to manipulate the strap S to move through the strap path such that upper and lower strap portions UP and LP, respectively, are positioned between the sonotrode head 830 and the anvil 720. As the ultrasonic sealer 810 moves from the retracted position to the sealing position, it moves toward the anvil 720 and passes through the strap path. FIG. 9B shows the ultrasonic-sealing assembly 800 after it has begun moving from the retracted position to the sealing position. Here, the contact surfaces 834c of the sonotrode teeth 834 have contacted the underside of the lower strap portion LP and caused the upper and lower strap portions UP and LP to rotate so they too form the angle θ relative to a horizontal axis. FIG. 9C shows the ultrasonic-sealing assembly 800 after it has reached the sealing position. Here, the sonotrode 810 forces the upper surface of the upper strap portion UP against the contact surfaces 734c of the anvil teeth 734. Because the anvil teeth 734 and the sonotrode teeth 834 are in a meshing arrangement with one another (i.e., the teeth of one component are positioned opposite respective grooves between the teeth of the other component), the upper and lower strap portions UP and LP bend and assume a substantially wavy profile (including alternating peaks and valleys) in the transverse direction as shown in FIG. 9C.

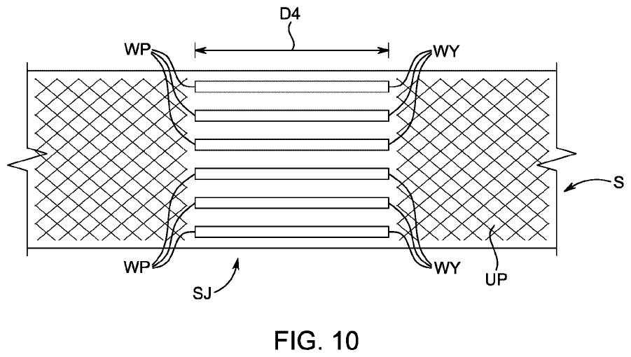

The ultrasonic transducer 840 is activated for a designated period while the ultrasonic sealer 810 forces the upper and lower strap portions UP and LP against the anvil 720. As explained above, this results in the sonotrode teeth 834 vibrating at an ultrasonic frequency that causes the upper and lower portions of strap UP and LP to locally melt together to form a strap joint. FIG. 10 shows such a strap joint SJ having a width D4—which corresponds to the length of the sonotrode teeth—extending in the longitudinal direction of the strap (horizontal from the perspective shown in FIG. 10), which is perpendicular to the transverse direction of the strap (vertical from the perspective shown in FIG. 10). The width D4 is 14 millimeters in this example embodiment, though it may be any other suitable value in other embodiments. As shown in FIG. 9C, the cross-section of the strap joint SJ has a wavy profile with several alternating peaks WP and valleys WV formed by the offset anvil and sonotrode teeth.

Generally, the strap-feeding assembly 400, the strap-tensioning assembly 500, and the strap-sealing assembly 600 are together configured to form a tensioned strap loop around the load 50 by feeding strap S through the strap chute 150 in a feed direction, holding the leading strap end while retracting the strap S in a retract direction to remove it from the strap chute 150 so it contacts the load 50, tensioning the strap S around the load 50 to a designated tension, attaching two overlapping portions of the strap S to one another to form a strap joint, and cutting the strap S from the strap supply. In this example embodiment, the strapping machine 10 is a “tabletop” strapping machine in which the frame 100 supports the strap-feeding assembly 400, the strap-tensioning assembly 500, and the strap-sealing assembly 600. In other embodiments, one or more of these assemblies is not supported by the frame 100. For instance, in certain embodiments in which the strapping machine is configured to strap large loads, such as palletized loads, loads of lumber, or loads of corrugated, these assemblies are distinct, independently replaceable modules supported by different components of the strapping machine.

The controller includes a processing device (or devices) communicatively connected to a memory device (or devices). For instance, the controller may be a programmable logic controller. The processing device may include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine. The memory device may include any suitable memory device such as, but not limited to, read-only memory, random-access memory, one or more digital registers, cache memory, one or more semiconductor memory devices, magnetic media such as integrated hard disks and/or removable memory, magneto-optical media, and/or optical media. The memory device stores instructions executable by the processing device to control operation of the strapping machine 10, such as to carry out the strapping process described below.

In this example embodiment, the controller is operably connected to the strap-feeding actuator 430, the strap-tensioning actuator 530, and the strap-sealing actuator 615 and configured to control the output of these actuators. The controller is operably connected to the ultrasonic transducer 840 and configured to operate it. The controller is communicatively connected to and configured to receive signals from and send signals to the leading-end sensor.

Operation of the strapping machine 10 to carry out the strapping process is now described. During the strapping process, the strapping machine is configured to carry out: a strap-feeding process by feeding strap from a strap supply around a strap chute that surrounds the load; a strap-retraction process by pulling the strap out of the strap chute and onto and around the load; a strap-tensioning process by tensioning the strap around the load to a designated strap tension; and a strap-sealing process by attaching two portions of the strap to one another to form a strap joint.

After initiation of the strapping process, the controller initiates the strap-feeding process and drives the strap-feeding actuator 430 to drive the drive roller 410 in the feed rotational direction to feed the strap S from the strap supply in the feed direction through various guides, through the strap passage of the first strap clamp 640, through the leading-end guide 630 and into and around the strap chute 150. The leading end LE of the strap S eventually reaches a leading-end stop of the head 716 of the anvil support 710, at which point the leading-end sensor senses the leading end LE and sends an appropriate signal to the controller. In response, the controller stops driving the strap-feeding actuator 430 to stop the drive roller 410 and complete the strap-feeding process. FIG. 11A shows the strap S and the configuration of the strap-sealing assembly 600 at this point.

After the strap-feeding process is complete, the controller initiates the strap-retraction process and drives the strap-sealing actuator 615 to move the leading-end guide 630 to its retracted position and the first strap clamp 640 to its clamping position such that the clamping surface 640s of the first strap clamp 640 clamps part of the strap S spaced-apart from the leading end LE of the strap S against the underside of the head 716 of the anvil support 710. The controller drives the strap-feeding actuator 430 to drive the drive roller 410 in the retract rotational direction to pull the strap S in the retract direction and out of the strap chute 150 and onto and around the load, at which point the controller stops driving the strap-feeding actuator 430 to stop the drive roller 410 and complete the strap-retraction process. FIG. 11B shows the strap S and the configuration of the strap-sealing assembly 600 at this point.

After the strap-retraction process is complete, the controller initiates the strap-tensioning process and drives the strap-tensioning actuator 530 to drive the drive roller 510 in the tensioning rotational direction to pull the strap S in the retract direction and tension the strap S around the load. As this occurs, the controller monitors the electrical current drawn by the strap-tensioning actuator 530. Once the current draw reaches a predetermined amount that is correlated with a predetermined strap tension, the controller stops driving the strap-tensioning actuator 530 to stop the drive roller 510 and complete the strap-tensioning process. FIG. 11B shows the strap S and the configuration of the strap-sealing assembly 600 at this point.

After the strap-tensioning process is complete, the controller initiates the strap-sealing process and drives the strap-sealing actuator 615 to move the second strap clamp 650 to its clamping position such that the clamping surface 650s of the second strap clamp 650 clamps a portion of the strap S against the underside of the head 716 of the anvil support 710, as shown in FIG. 11C. Continued driving of the strap-sealing actuator 615 moves the ultrasonic-sealing assembly 800—and particularly the sonotrode head 830 of the ultrasonic sealer 810—to its sealing position such that the sonotrode teeth 834 force the upper and lower strap portions UP and LP against the anvil teeth 734, as explained above. Simultaneously, the strap-sealing actuator 615 moves the strap cutter to its cutting position to cut the strap S from the strap supply. FIG. 11D shows the strap S and the configuration of the strap-sealing assembly 600 at this point. The controller activates the ultrasonic transducer 840 to form the seal joint SJ, as described above.

Continued driving of the strap-sealing actuator 615 moves the ultrasonic-sealing assembly 800, the anvil assembly 700, the first and second strap clamps 640 and 650, and the strap cutter 660 to their respective retracted positions, as shown in FIG. 11E. This releases strap S from the strapping head 300, thereby enabling the now-strapped load 50 to be removed from the strapping device 10.

Although the ultrasonic-sealing assembly and ultrasonic sealer are described above as part of a strapping machine, the ultrasonic-sealing assembly and in particular the ultrasonic sealer may be employed in any other suitable strapping device, such as a handheld strapping tool or a modular strapping head.

1. A strapping device comprising:
an anvil comprising multiple anvil teeth that define an anvil contact plane angularly offset from a horizontal axis by a first nonzero angle; and
an ultrasonic sealer comprising:
a sonotrode comprising multiple sonotrode teeth that define a sonotrode contact plane angularly offset from the horizontal axis by the first nonzero angle; and
an ultrasonic transducer configured to generate mechanical vibrations at an ultrasonic frequency and to transmit the mechanical vibrations to the sonotrode,
wherein the ultrasonic sealer extends longitudinally along an ultrasonic-sealer axis that is angularly offset from a vertical axis by a second nonzero angle, and
wherein the ultrasonic sealer is movable along the ultrasonic-sealer axis between a retracted position in which the sonotrode teeth are spaced-apart from the anvil teeth and a sealing position in which the sonotrode teeth are in a meshing arrangement with the anvil teeth.

2. The strapping device of claim 1, wherein each of the sonotrode teeth includes a contact surface, wherein the contact surfaces of the sonotrode teeth define the sonotrode contact plane.

3. The strapping device of claim 2, wherein the contact surfaces are planar.

4. The strapping device of claim 1, wherein the sonotrode contact plane is substantially perpendicular to the ultrasonic-sealer axis.

5. The strapping device of claim 1, wherein the first nonzero angle and the second nonzero angle are substantially the same.

6. The strapping device of claim 5, wherein the first nonzero angle and the second nonzero angle are each approximately 20 degrees.

7. The strapping device of claim 1, wherein the anvil teeth and the sonotrode teeth extend substantially parallel to a strap path defined through the strapping device.

8. The strapping device of claim 7, wherein each of the sonotrode teeth includes a contact surface, wherein the contact surfaces of the sonotrode teeth define the sonotrode contact plane.

9. The strapping device of claim 8, wherein the contact surfaces are planar.

10. The strapping device of claim 1, further comprising an ultrasonic-sealer support comprising:
a first support to which the ultrasonic transducer is mounted;
a second support; and
a biasing element,
wherein the first support and the second support have a first configuration in which the first and second supports are separated by a first distance and a second configuration in which the first and second supports are separated by a second distance,
wherein the first distance is greater than the second distance,
wherein the biasing element is configured to bias the first and second supports to the first configuration.

11. The strapping device of claim 10, wherein the anvil teeth and the sonotrode teeth extend substantially parallel to a strap path defined through the strapping device.

12. The strapping device of claim 10, wherein the first support is movable relative to the second support along the ultrasonic-sealer axis.

13. The strapping device of claim 1, wherein the ultrasonic transducer is configured to generate the mechanical vibrations at an ultrasonic frequency of approximately 35 kilohertz.

14. The strapping device of claim 13, wherein the first nonzero angle and the second nonzero angle are each approximately 20 degrees.

15. The strapping device of claim 14, wherein the anvil teeth and the sonotrode teeth extend substantially parallel to a strap path defined through the strapping device.

16. A strapping device comprising:
an anvil comprising multiple anvil teeth that extend substantially parallel to a strap path defined through the strapping device; and
an ultrasonic sealer comprising:
a sonotrode comprising multiple sonotrode teeth that extend substantially parallel to the strap path, wherein each sonotrode tooth comprises opposing angled side surfaces that define grooves between adjacent sonotrode teeth, wherein a cross-section of each groove is substantially the same along a length of that groove; and
an ultrasonic transducer configured to generate mechanical vibrations at an ultrasonic frequency and to transmit the ultrasonic mechanical vibrations to the sonotrode,
wherein the ultrasonic sealer is movable along the ultrasonic-sealer axis between a retracted position in which the sonotrode teeth are spaced-apart from the anvil teeth and a sealing position in which the sonotrode teeth are in a meshing arrangement with the anvil teeth.

17. The strapping device of claim 16, wherein the angled side surfaces of each pair of adjacent sonotrode teeth are separated by a first angle, wherein the first angle is between 60 and 120 degrees.

18. The strapping device of claim 17, wherein the first angle is about 90 degrees.

19. The strapping device of claim 16, wherein each sonotrode tooth includes a contact surface extending between the two opposing angled side surfaces of that sonotrode tooth.

20. The strapping device of claim 19, wherein the contact surface of each sonotrode tooth is planar.

21. The strapping device of claim 20, wherein the angled side surfaces of each sonotrode tooth are planar such that the grooves have a substantially V-shaped cross-section.

22. The strapping device of claim 21, wherein the angled side surfaces of each pair of adjacent sonotrode teeth are separated by a first angle, wherein the first angle is about 90 degrees.

23. The strapping device of claim 16, wherein each anvil tooth comprises opposing angled side surfaces that define grooves between adjacent anvil teeth, wherein each groove of the anvil is sized and shaped to receive one of the sonotrode teeth when the sonotrode teeth are in the meshing arrangement with the anvil teeth.

24. The strapping device of claim 23, wherein the angled side surfaces of each pair of adjacent sonotrode teeth are separated by a first angle, wherein the angled side surfaces of each pair of adjacent anvil teeth are separated by the first angle, wherein the first angle is between 60 degrees and 120 degrees.

25. The strapping device of claim 24, wherein the first angle is about 90 degrees.

26. The strapping device of claim 23, wherein each sonotrode tooth includes a contact surface extending between the two opposing angled side surfaces of that sonotrode tooth, wherein each anvil tooth includes a contact surface extending between the two opposing angled side surfaces of that anvil tooth.

27. The strapping device of claim 26, wherein the contact surface of each sonotrode tooth and each anvil tooth is planar.

28. The strapping device of claim 27, wherein the angled side surfaces of each sonotrode tooth and each anvil tooth are planar such that the grooves of the anvil and the sonotrode have a substantially V-shaped cross-section.

29. The strapping device of claim 28, wherein the angled side surfaces of each pair of adjacent sonotrode teeth are separated by a first angle, wherein the angled side surfaces of each pair of adjacent anvil teeth are separated by the first angle, wherein the first angle is about 90 degrees.
